(19) United States
(12) Patent Application Publication
(10) Pub. No.: US 2012/0030356 A1
(43) Pub. Date: Feb. 2, 2012

(54) MAXIMIZING EFFICIENCY IN A CLOUD COMPUTING ENVIRONMENT

(75) Inventor: James C. Fletcher, Apex, NC (US)

(73) Assignee: International Business Machines Corporation, Armonk, NY (US)

(21) Appl. No.: 12/847,116

(22) Filed: Jul. 30, 2010

(51) Int. Cl. G06F 15/173

(52) U.S. Cl. 709/226

(57) ABSTRACT

Power consumption efficiency of servers and data centers that comprise the servers can be taken into consideration when identifying servers from which to allocate resources for servicing a request. A subset of a plurality of servers from which resources can be allocated to service the request can be identified based on availability of resources at each of the plurality of servers. Facilities elements (including power distribution elements and cooling elements) associated with the each server of the subset of the plurality of servers are identified. An energy cost for each server of the subset of the plurality of servers is calculated based on power characteristics of the facilities elements. Resources of a first of the subset of the plurality of servers are allocated for servicing the request is identified based on determining that the first of the subset of the plurality of servers is associated with a lowest energy cost.

### BACKGROUND

Embodiments of the inventive subject matter generally relate to the field of energy conservation aware computing and, more particularly, to maximizing power utilization efficiency through physical location correlation.

In a cloud-computing environment, resources (e.g., physical servers and other peripherals) are aggregated into a “cloud” for servicing a request. A client requests resources from the cloud rather than from a specific server or other resource. Any one or more of the servers are selected based on capacity of the servers (e.g., available memory and processor resources) and ability of the servers to service the request. For example, memory may be allocated to a requesting client from any server within the cloud network based on availability of memory at the server.

### SUMMARY

Embodiments include a method comprising determining a plurality of servers from which resources can be allocated to service a request. A power distribution element and a cooling element associated with each server of the subset of the plurality of servers are identified. An energy cost for each server of the plurality of servers is calculated based, at least in part, on power characteristics of the power distribution element and the cooling element associated with the server. A lowest energy cost for servicing the request is determined based, at least in part, on determining the energy cost for each of the plurality of servers. At least a subset of the resources is allocated for servicing the request from a first of the plurality of servers based, at least in part, on determining the lowest energy cost for servicing the request.

### BRIEF DESCRIPTION OF THE DRAWINGS

The present embodiments may be better understood, and numerous objects, features, and advantages made apparent to those skilled in the art by referencing the accompanying drawings.

FIG. 1 is a conceptual diagram illustrating example operations for allocating resources based on power consumption of servers in a cloud network.

FIG. 2 depicts a flow diagram illustrating example operations for allocating resources of a server based on power consumption efficiency of the server

FIG. 3 is a continuation of FIG. 2 and also illustrates example operations for allocating resources of a server based on power consumption efficiency of the server

FIG. 4 is a flow diagram illustrating example operations for constructing a power consumption database.

FIG. 5 is an example block diagram of a computer system configured for identifying servers from which to allocate resources based on power consumption of the servers.

FIG. 6 is an example block diagram configured for allocating resources based on server energy efficiency.

### DESCRIPTION OF EMBODIMENT(S)

The description that follows includes exemplary systems, methods, techniques, instruction sequences, and computer program products that embody techniques of the present inventive subject matter. However, it is understood that the described embodiments may be practiced without these specific details. For instance, although examples refer to allocating resources from one or more collocated servers (e.g., servers within a common data center), embodiments are not so limited. In other embodiments, the servers from which the resources are allocated may be located at different physical locations (e.g., within different data centers). In other instances, well-known instruction instances, protocols, structures, and techniques have not been shown in detail in order not to obfuscate the description.

To enable cloud computing, a resource management unit allocates server resources for servicing a request based on available resources at the server and the server's ability to service the incoming request. If there are multiple servers from which resources can be allocated for servicing the request, the resource management unit randomly selects one of the servers from which to allocate resources for servicing the incoming request. In other words, there is no consideration to optimize selection of an appropriate server based on power requirements of the server or to optimize selection of an appropriate server based on facilities elements (e.g., cooling units, power distribution units, etc.) associated with the server. Because each server may have a different energy impact in a cloud network, selection of a server from which resources are allocated for servicing the request can have a measurable impact on the overall energy efficiency of the cloud network.

Energy efficiency of the server and consequently of the cloud network can be improved by taking into consideration relationships between the servers of the cloud network and the facilities elements of the cloud network. On receiving a request to be serviced, the resource management unit can be configured to calculate an energy cost for the servers that constitute a cloud network. The energy cost for each server can be determined based on various factors including power supplied to the server, heat generated at the server, power supplied to the cooling units associated with the server, a current workload of the server, an estimated increase in power consumption if resources of the server are allocated for servicing the request, etc. The resource management unit can identify one or more servers associated with a lowest energy cost. The resource management unit can allocate resources (subset of available resources) of the one or more identified servers for servicing the request. By maintaining awareness of physical location of the servers, relationships between the servers and their associated facilities equipment, and the power consumption of the servers and their associated facilities equipment, resources of appropriate server(s) can be allocated for servicing the request based on power consumption and an energy cost associated with the server(s). This can improve power efficiency of the server and consequently power efficiency of the cloud network that comprises the server.

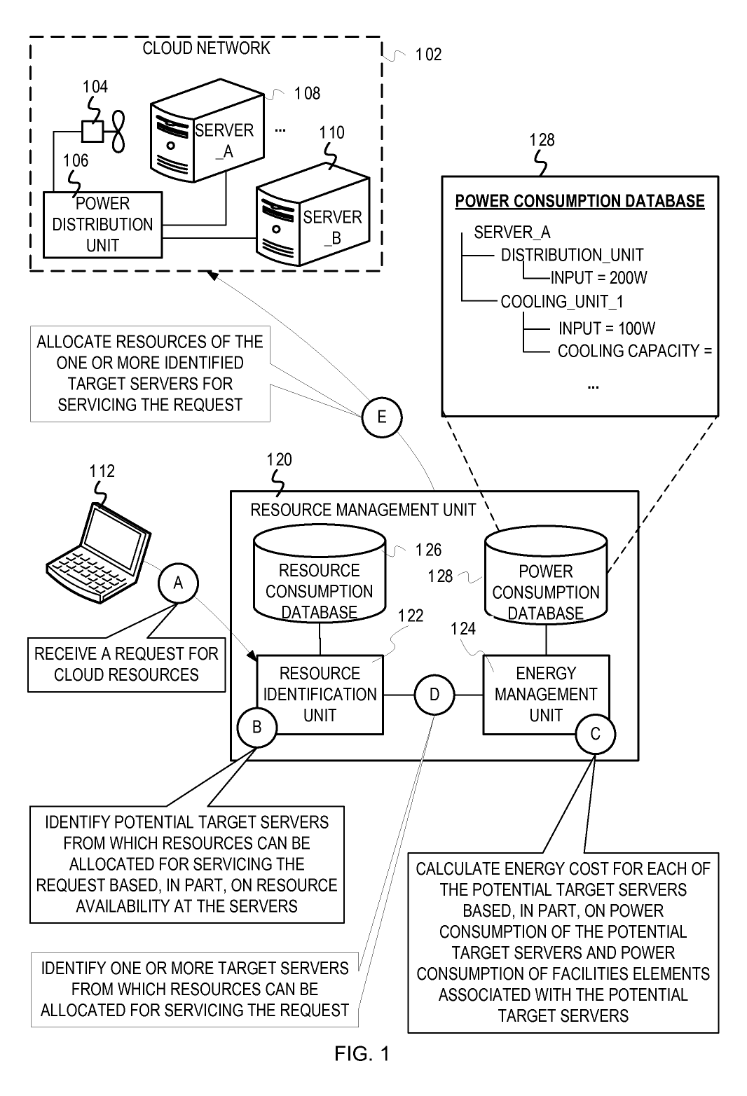

FIG. 1 is a conceptual diagram illustrating example operations for allocating resources based on power consumption of servers in a cloud network. FIG. 1 depicts a cloud network 102, a client 112, and a resource management unit 120. The cloud network comprises a server_A 108 and a server_B 110. A cooling element 104 cools (i.e., dissipates heat generated by) the server 108. The cloud network 102 also depicts a power distribution unit 106 supplying power to the server 108, the server 110, and the cooling element 104. The resource management unit 120 comprises a resource identification unit 122, an energy management unit 124, a resource consumption database 126, and a power consumption database 128. It should be noted that although FIG. 1 depicts a single cooling unit 104, two servers 108 and 110, and a power distribution unit 106, the cloud network 102 could comprise any suitable number of servers, power distribution units, and cooling units.

The power consumption database 128 maintains relationships between the servers 108 and 110 and their respective facilities elements. The facilities elements include cooling elements (e.g., the cooling element 104) and power distribution units (e.g., the power distribution unit 106) that supply power to the servers 108 and 110 and to the cooling unit 104. As depicted in FIG. 1, the power consumption database 128 is implemented as a tree structure comprising the server 108 that constitutes the cloud network 102 and the facilities elements (e.g., the cooling element 104 and the power distribution unit 106) associated with the server 108. The power consumption database 128 also indicates a power provided by the power distribution unit 106 to the server 108, a power provided to the cooling unit 104, a cooling capacity of the cooling unit 104, etc. For simplicity, only some of the relationships between the server 108 and the cooling element 104 and the power distribution unit 106 are depicted. It is noted, however, that the cloud network 102 can comprise various other cooling elements (e.g., cooling fans, air conditioners, chillers, etc.), power distribution units (e.g., uninterrupted power supply units, mains distribution units, powerline conditioners, switchgear, battery backups, generators, switching boxes, distribution cables, etc.), and servers. Also, in the cloud network 102, more than one power distribution unit may supply power to the servers and more than one cooling unit may dissipate heat generated by the servers. Accordingly, the power consumption database 128 can depict additional relationships not illustrated in FIG. 1. The power consumption database 128 can indicate a power loss at the power distribution unit 106, power loss in power distribution cables, an airflow capacity of the cooling unit 104, a direction of airflow, a distance from the cooling unit 104 to the server 108, a power consumption of the cooling unit 104, and other such factors. The resource consumption database 126 maintains a record of available resources at the servers 108 and 110. The available resources can include memory available for allocation at the servers 108 and 110, processor usage levels, etc. The resource identification unit 122 in conjunction with the energy management unit 124 identifies one or more servers from which resources can be allocated for servicing a request based, at least in part, on power consumption by the servers and their associated facilities elements as will be described below in stages A-E.

At stage A, the resource management unit 120 receives a request for cloud resources from the client 112. The request received from the client 112 can indicate levels of cloud resources required. The cloud resources can comprise processor resources and memory resources. For example, the client 112 may transmit a request to the resource management unit 120 for 64 KB of memory. The resource management unit 120 can be implemented within the cloud network 102 (e.g., on a centralized server within the cloud network 102) or may be external to the cloud network 102.

At stage B, the resource identification unit 122 identifies potential target servers from which resources can be allocated for servicing the request based, in part, on resource availability at the servers. The resource identification unit 122 accesses the resource consumption database 126 to identify a percentage of resources of the servers 108 and 110 that have already been allocated. The resource consumption database 126 can comprise an indication of total resources of the server 108 (e.g., a total memory of the server), a percentage of allocated resources of the server 108, a percentage of unallocated resources of the server 108 (e.g., resources that are available for allocation), etc. In some implementations, the unallocated resources of the server 108 may be less than a difference between the total resources of the server 108 and the allocated resources of the server 108. The unallocated resources of the server 108 may also be determined by taking into consideration a minimum amount of unallocated resources required to maintain operating performance of the server 108 and to prevent crashing/freezing of the server 108. The resource identification unit 122 can compare the unallocated resources of the server 108 with a threshold operating capacity of the server 108. The server 108 may be identified as a potential target server if the server 108 operates below its threshold operating capacity. The resource identification unit 122 can also determine whether the server 108 is in a dormant state (e.g., in an idle state or an inactive state) and/or whether facilities elements (e.g., the cooling unit 104) associated with the server 108 are in the inactive state. If so, the resource identification unit 122 may not identify the server 108 as a potential target server and may instead indicate that resources of the server 108 cannot be allocated for servicing the request. It is noted, however, that in some implementations, the server in the dormant state may be activated (e.g., by powering on the server) based on an energy policy of the data center that comprises the server in the dormant state. For example, if none of the currently active servers in the cloud network 102 can service the request, the server in the dormant state may be activated and resources of the previously dormant server may be allocated for servicing the request.

At stage C, the energy management unit 124 calculates an energy cost for each of the potential target servers based, in part, on power consumption of the potential target servers and power consumption of the facilities elements associated with the potential target servers. The energy management unit 124 accesses the power consumption database 128 to identify the facilities elements associated with the potential target servers. In FIG. 1, the energy management unit 124 accesses the power consumption database 128 and determines that power distribution unit 106 provides power to the server 108 and that the cooling unit 104 dissipates heat generated by the server 108. The power consumption of the server 108 can be determined based, in part, on knowledge of power drawn by the server 108 (i.e., power provided by the power distribution unit 106 to the server 108) and heat generated by the server 108 (or temperature at the server 108). The power consumption of the cooling unit 104 can be determined based on knowledge of power drawn by the cooling unit 104, heat generated by the cooling unit 104, cooling efficiency of the cooling unit 104, etc. In some implementations, the server 108 and the cooling unit 104 may be connected to power meters that track power consumption of the server 108 and the cooling unit 104 respectively.

Additionally, the energy management unit 124 can determine a factor by which the power consumption of the server 108 may increase (“power consumption increment”) if at least a subset of the available resources of the server 108 are allocated for servicing the request received at stage A. The energy management unit 124 may receive an indication of the subset of available resources of the server 108 that may be allocated for servicing the request and/or an indication of a future workload of the server 108. For example, the energy management unit 124 may receive an indication that 50% of the server's memory resources are currently allocated and that 60% of the memory resources will be allocated if the server 108 services the request. The energy management unit 124 can estimate a temperature increase at the server 108 and an additional heat that will be generated by the server 108 if 60% of the memory resources of the server 108 are allocated for servicing the request. The power consumption increment can be calculated based on the estimated temperature increase, a power specification of the server 108, maximum temperature of processing units of the server 108, a thermal metric of a motherboard, technology used to implement the server 108, etc. The energy management unit 124 can also determine how much additional power will be drawn by the server 108 from the power distribution unit 106, whether the power distribution unit 106 can provide the additional power, and whether another power distribution unit may be required to provide the additional power to the server 108. Based on the power consumption of the server 108, the power consumption of the facilities elements associated with the server 108, and the power consumption increment of the server 108, the energy management unit 124 calculates the energy cost associated with the server 108.

At stage D, the resource identification unit 122 identifies one or more target servers as a most appropriate of the potential target servers from which resources can be allocated for servicing the request. Based on the energy cost associated with each of the potential target servers, the resource identification unit 122 identifies the target server as the potential target server with the lowest energy cost. The resource identification unit 122 determines whether sufficient resources are available at the identified target server to service the request received at stage A. If sufficient resources are not available at the identified target server, additional target servers (e.g., potential target servers with the next lowest energy cost, a group of servers with a lowest aggregate energy cost) can be identified.

At stage E, the resource management unit 120 allocates resources of the one or more identified target servers for servicing the request. In some implementations, the resource management unit 120 may be part of or may interact with a virtual memory manager (not shown) to allocate resources, from the identified target servers, for servicing the request. Based on knowledge of the identified one or more target servers (determined at stage D), the virtual memory manager can map virtual addresses provided for servicing the request to available physical memory of the identified one or more target servers.

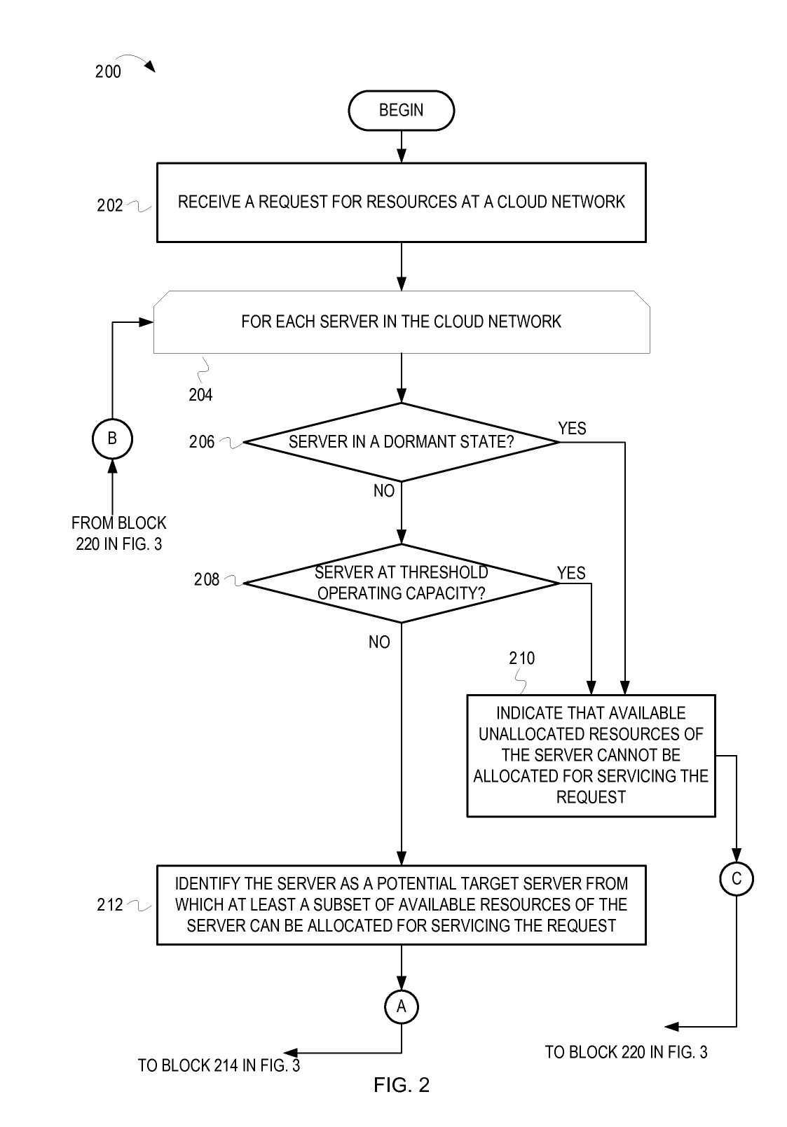

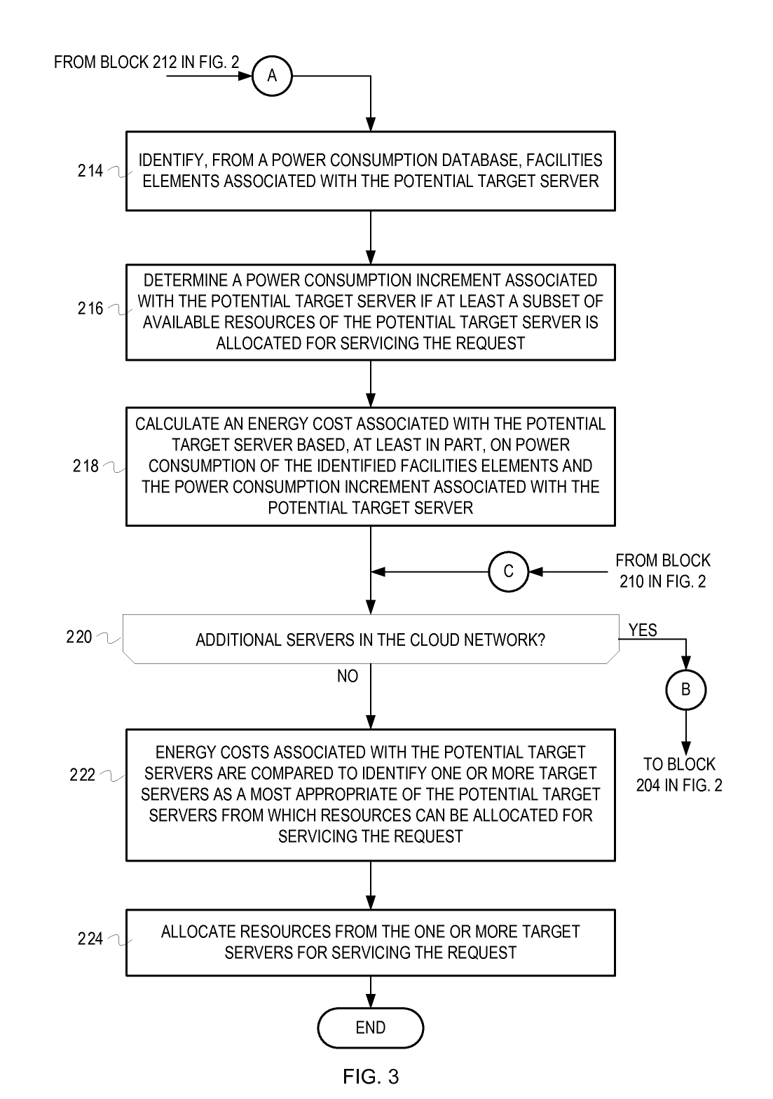

FIG. 2 and FIG. 3 depict a flow diagram illustrating example operations for allocating resources of a server based on power consumption efficiency of the server. Flow 200 begins at block 202 in FIG. 2.

A request for resources is received at a cloud network (202). As described above, the cloud network comprises an aggregation of resources that can be allocated for servicing requests. The request received at block 202 can indicate memory requirements of a client (e.g., an amount of memory required for running programs, executing operations, and storing data) and processor requirements (e.g., processor frequency, processor clock rate, etc.). In some implementations, the request may be for accessing services or shared information technology (IT) components (e.g., storage, routers, switches, keyboards, mice, printing devices, and other peripherals) of the cloud network. The flow continues at block 204.

A loop begins for each server in the cloud network (204). Operations described with reference to blocks 206-218 are executed for each server in the cloud network to identify target servers from which resources can be allocated for servicing the request received at block 202. The flow continues at block 206.

It is determined whether the server is in a dormant state (206). To determine whether the server is the dormant state, it may be determined whether the server is switched off, is operating at low power, or is in an idle state to conserve power. Furthermore, facilities elements associated with the server in the dormant state may also be switched off or may be operated at low power. If the server is in the dormant state, resources of the server may not be allocated for servicing the request in an effort to enable power conservation at the server. For example, it may be determined whether a server rack that comprises the server is being utilized. Selecting a server from a server rack that is currently not being utilized, can result in an increase in cooling requirements for the server rack, an increase in power consumption of cooling units associated with the server and the server rack, and an increase in power consumption of power distribution units associated with the server and the sever rack. In other words, servers that are not in the dormant state may be preferentially selected over servers that are in the dormant state to minimize an increase in power consumption after allocating resources for servicing the request. In some implementations, the server in the dormant state may be selected based on an energy policy of the data center that comprises the server in the dormant state, based on an energy policy associated with the cloud network, etc. For example, if none of the active servers in the cloud network 102 can service the request, the server in the dormant state may be activated and resources of the previously dormant server may be allocated for servicing the request. If it is determined that the server is in the dormant state, the flow continues at block 210. Otherwise, the flow continues at block 208.

It is determined whether the server is at threshold operating capacity (208). A resource consumption database (e.g., the resource consumption database 126 of FIG. 1) may be accessed to determine a percentage of resources of the server that are currently allocated for servicing requests. For example, it may be determined that 60% of memory of the server is currently allocated for servicing requests and that 40% of the memory of the server is unallocated. The available unallocated memory of the server may be compared against a memory threshold to determine whether the server is at the threshold operating capacity. The memory threshold may be determined based on performance characteristics of the server, historical analysis, simulations, and knowledge of a maximum percentage of the resources of the server that can be allocated without compromising requisite performance (e.g., latency, CPU frequency, etc.) of the server. For example, based on knowledge that the server's performance can deteriorate after 70% of the memory of the server is allocated, the memory threshold associated with the server may be set to 20%. In other words, if the available unallocated memory of the server is less than 20% of the total memory of the server, the available unallocated memory of the server may not be allocated for servicing the request (received at block 202). Likewise, a current processor usage of the server may be determined and may be compared against a threshold processor usage. The processor of the server may not be allocated unless the current processor usage of the server is less than the threshold processor usage. In some implementations, because the operating characteristics of the servers may differ, each server may be associated with a different threshold operating capacity (i.e., a different memory threshold, a different threshold processor usage, etc.). In other implementations, the servers may be associated with a common threshold operating capacity based on a lowest threshold operating capacity. If it is determined that the server is at its threshold operating capacity, the flow continues at block 210. Otherwise, the flow continues at block 212.

It is determined that available unallocated resources of the server cannot be allocated for servicing the request (210). The flow 200 moves from block 206 to block 210 on determining that the server is in the dormant state. The flow 200 also moves from block 208 to block 210 if it is determined that the server is at its threshold operating capacity. A flag associated with the server may be updated to indicate that available unallocated resources of the server cannot be allocated for servicing the request. The flow continues at block 220 in FIG. 3, where it is determined whether there exist additional servers to be analyzed.

The server is identified as a potential target server from which at least a subset of available unallocated resources of the server can be allocated for servicing the request (212). The flow 200 moves from block 208 to block 212 if it is determined that the server is not in a dormant state and that the server is not at its threshold operating capacity. In some implementations, on determining that at least a subset of unallocated resources of the server can be allocated for servicing the request received at block 202, a flag associated with the server may be updated to identify the server as a potential target server. The flow continues at block 214 in FIG. 3.

Facilities elements associated with the potential target server are identified from a power consumption database (214). As described above, the facilities elements include power distribution units that supply power to the potential target server and cooling units that dissipate heat generated by the potential target server. The power distribution units can comprise uninterrupted power supply (UPS) units, mains distribution units, powerline conditioners, switchgear, battery backups, generators, switching boxes, distribution cables, etc. The cooling units can comprise fans, air conditioners, air vents, chilling devices, pumps, cooling towers, water cooling equipment, and other such devices that can dissipate heat generated by the potential target server. The power consumption database (e.g., the power consumption database 128 of FIG. 1) can indicate power distribution units that supply power to the potential target server and can also indicate cooling units that are associated with the potential target server. The cooling units associated with the potential target server may be identified as the cooling units that generate airflow in the direction of the potential target server and that are within a threshold distance from the potential target server. For example, based on accessing the power consumption database, it may be determined that a first UPS supplies power to the potential target server and that a first cooling fan and a first air vent dissipate heat generated by the potential target server.

The power consumption database can also indicate characteristics of the facilities elements associated with the potential target server. For example, the power consumption database can indicate power characteristics of the power distribution units including a power provided to the potential target server, a power provided to cooling units associated with the potential target server, a power received from a power supply, power loss characteristics of the power distribution unit, coupling losses, power losses in the distribution lines, a maximum power that can be supplied by the power distribution unit, a power supplying efficiency of the power distribution unit (e.g., how much of the power received from a mains distribution unit is converted into heat), etc. The power consumption database can also indicate characteristics of the cooling units including power received from the power distribution unit, a cooling capacity and cooling efficiency of the cooling unit, an airflow of the cooling unit, a direction of the airflow relative to the potential target server, a distance of the cooling unit from the potential target server, cooling ratings of the cooling unit, etc. The power consumption database can also indicate a current temperature of the potential target server, a temperature at which the cooling units attempt to maintain the potential target server, and an impact of temperature increase at the potential target server on power drawn by the cooling units. The power consumption of the potential target server and the cooling units can be calculated (as will be described with reference to block 216) based on knowledge of the characteristics of the power distribution units and the characteristics of the cooling units. The flow continues at block 216.

A power consumption increment associated with the potential target server, if at least a subset of available resources of the potential target server is allocated for servicing the request, is determined (216). Based on knowledge of a percentage of the available unallocated resources of the potential target server that will be allocated for servicing the request, a future workload of the potential target server can be determined. For example, it may be determined that after currently unallocated memory of the potential target server is allocated for servicing the request, 60% of the total memory of the potential target server will be allocated. A temperature rise at the potential target server (or the additional heat generated by the potential target server) and consequently the power consumption increment associated with the potential target server can be estimated based knowledge of the future workload of the potential target server, the percentage of resources of the potential target server that will be allocated, and power/temperature characteristics of the potential target server. The temperature rise and consequently the power consumption increment associated with the potential target server can also be estimated, based on knowledge of the potential target server including power specification of the potential target server, maximum temperature of a processor, thermal metric of a motherboard, technology of the potential target server, a frequency and voltage at which the potential target server operates, etc. The power consumption increment can be calculated based on simulations, accumulated data, historical analysis, and trends in resource allocation versus power consumption, server temperature, and heat generation.

Based on knowledge of the temperature rise at the potential target server, it may be determined whether additional cooling units will be required to dissipate the heat generated by the potential target server. An increase in power consumption by the cooling units may also be determined. Furthermore, in calculating the power consumption increment, an additional power that will be drawn by the potential target server and the cooling units may be determined. It may be determined whether the existing power distribution unit associated with the potential target server can provide the additional power to the potential target server or whether new power distribution units will be required to provide the additional power to the potential target server and to the cooling units. The flow continues at block 218.

An energy cost associated with the potential target server is calculated based, at least in part, on power consumption of the identified facilities elements and the power consumption increment associated with the potential target server (218). In one implementation, the energy cost associated with the potential target server can be calculated in terms of power usage effectiveness (PUE) of a data center that comprises the potential target server based on knowledge of the power consumed by the servers of the data center, the power consumed by the facilities elements of the data center, and an estimate of the power consumption increment for the potential target server. The PUE is a measure of energy efficiency of the data center. The PUE can be determined as a ratio of power entering the data center (e.g., power consumed by the power distribution units, the cooling units, and IT equipment) to the power consumed by the IT equipment within the data center. For example, a data center with a PUE of 3, requires three times more power to operate than the IT equipment within the data center. In other words, if the power consumption of the servers within the data center is 500 W, the data center (i.e., a combination of the power distribution units, the cooling units, and the servers) consumes 1500 W. Thus, the smaller the PUE, the more efficient the data center. If it is determined that a server in the dormant state is to be activated, the energy costs associated with the server may also take into account energy costs associated with the server switching from the dormant state to the active state, additional power to be provided by the power distribution units for operating the server, additional power that will be drawn by the cooling units for cooling the server, whether additional power distribution unit(s) and/or cooling unit(s) are to be enabled, etc. In another implementation, additional energy consumption elements (e.g., peripheral components, management servers, etc.) of the data center can be identified and power consumption of the additional energy consumption elements can be determined. The power consumption of the additional energy consumption elements can also be taken into consideration when determining the PUE of the data center. In another implementation, the energy cost associated with the potential target server can be calculated in terms of total power consumption associated with the potential target server (e.g., a sum of power consumed by the potential target server and power consumed by the facilities elements associated with the potential target server). In some implementations, the energy cost associated with the potential target server may also be determined in terms of a monetary cost based on a total power consumption associated with the potential target server and knowledge of an energy cost/watt. An energy cost associated with a cloud network can also be calculated. For example, a cloud network may comprise two data centers—each data center comprising multiple servers. Based on knowledge of the power consumed by the servers, the power consumed by the facilities elements associated with the servers, and an estimate of the power consumption increment for the servers, an energy cost can be calculated for each of the data centers and also for the cloud network. As will be described below, the potential target server that results in the cloud network having the smallest energy cost may be selected. The flow continues at block 220.

It is determined whether there exist additional servers in the cloud network to be analyzed (220). If it is determined that there exist additional servers in the cloud network to be analyzed, the flow continues at block 204 in FIG. 2, where a next server is identified and operations described with reference to blocks 206-218 are executed for the next server. Otherwise, the flow continues at block 222.

Energy costs associated with the potential target servers are compared to identify one or more target servers as a most appropriate of the potential target servers from which resources can be allocated to service the request (222). The potential target servers may be organized in descending order of energy costs and the one or more target servers may be selected as the potential target servers associated with the lowest energy costs. Also, available resources of the target servers that can be allocated, without exceeding the threshold operating capacity of the target servers, can be compared with requested level of resources. The number of target servers selected from the potential target servers may be based on available unallocated resources at each of the potential target servers and on the requested level of resources. For example, a client may transmit a request for 1 MB of memory. A first target server associated with the lowest energy cost may be identified and it may be determined that 64 KB of memory of the first target server can be allocated without exceeding threshold operating capacity associated with the first target server. Thus, a second target server associated with a next lowest energy cost may be identified and 16 KB of memory of the second target server may be allocated to provide 1 MB of memory for servicing the request transmitted by the client. It is noted that if 16 KB of memory is not available for allocation from the second target server, a part of the memory resources (e.g., 8 KB) of the second target server may be allocated for servicing the request, a third target server with a next lowest energy cost may be identified, and the remaining 8KB of memory may be allocated from the third target server.

To identify multiple target servers from which resources can be allocated for servicing the request, multiple sets of potential target servers may be identified based on the availability of resources at the potential target servers and based on the amount of requested resources. The set of potential target servers may comprise one or more potential target servers. An aggregate energy cost associated with allocating resources from each set of potential target servers may be calculated. Resources for servicing the request may be allocated from the set of potential target servers with the lowest aggregate energy cost. For example, a request for 100 GB of memory and one processor core may be received. It may be determined that 100 GB of memory can be allocated from a first potential target server, that 50 GB of memory and the processor core can be allocated from a second potential target server, that 50GB of memory can be allocated from a third potential target server, and that a processor core can be allocated from a fourth potential target server. Three sets of potential target servers that can each be used to service the request can be determined as A) server set 1 comprises the first potential target server and the second potential target server, B) server set 2 comprises the first potential target server and the fourth potential target server, and C) server set 3 comprises the second potential target server and the third potential target server. An aggregate energy cost may be calculated for each of the three sets of potential target servers. The server set that is associated with the lowest energy cost may be selected and the potential target servers that constitute the identified server set may be designated as the target servers. Resources of the target servers that constitute the identified server set can be allocated for servicing the request. For example, if it is determined that the server set 3 is associated with the lowest of the aggregate energy costs, resources of the second server (i.e., 50 GB of memory and the processor core) and the third server (i.e., 50 GB of memory) can be allocated for servicing the request.

In some implementations, one or more of the potential target servers can be selected to maximize PUE efficiency of a data center. In one implementation, the servers of the cloud network can be located within a common data center. The target server can be selected to minimize the energy cost associated with the data center that comprises the target server. For example, the potential target server that results in the lowest energy cost associated with the data center may be selected as the target server. If the cloud network comprises more than one data center, the data center with the smallest data center energy cost may be selected. Resources of target servers within the selected data center may be allocated for servicing the request. The flow continues at block 224.

Resources from the one or more identified target servers are allocated for servicing the request (224). From block 224, the flow ends.

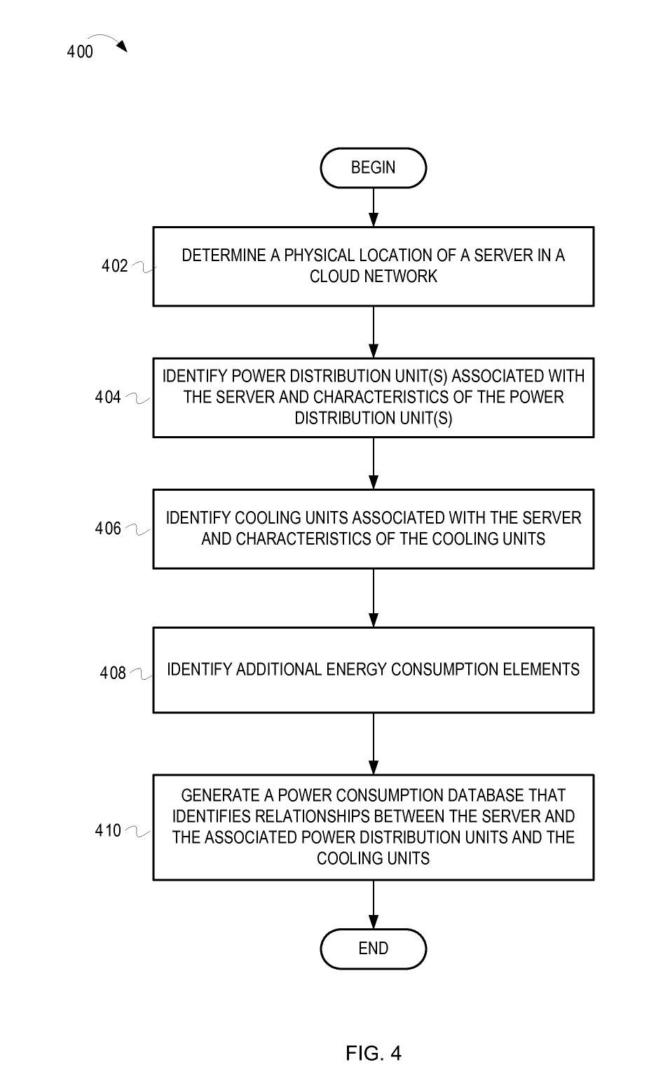

FIG. 4 is a flow diagram illustrating example operations for constructing a power consumption database. Flow 400 begins at block 402.

A physical location of a server in a cloud network is determined (402). The physical location of the server can comprise a geographic location of the server (e.g., latitude and longitude), a position of the server within a server rack, a position of the server with reference to a fixed position within a server room, etc. The position of the server may be determined in terms of Cartesian coordinates in three dimensions (i.e., x, y, and z coordinates). The x and y coordinates represent a horizontal position of the server while the z coordinate represents a relative height of the server. For example, the height of the server may be determined relative to the fixed position in the server room. The flow continues at block 404.

Power distribution unit(s) associated with the server and characteristics of the power distribution unit(s) are identified (404). The power distribution units can include uninterrupted power supply units, distribution lines, mains distribution units, powerline conditioners, and other power supply components that can provide power to servers, cooling units, and other components of a data center. The characteristics of a power distribution unit can include a physical location of the power distribution unit, a distance of the power distribution unit from the server, a power rating of the power distribution unit, an efficiency of the power distribution unit, and a maximum power that can be supplied by the power distribution unit. The characteristics of the power distribution unit may also include a monetary energy cost (e.g., power cost per Watt) at the power distribution unit. For example, based on knowledge of a geographic location of the power distribution unit, the monetary cost per Watt of power provided can be determined. In one implementation, the power distribution units can comprise functionality to determine and communicate their respective characteristics to a centralized processing unit that generates the power consumption database. For example, the resource management unit 120 of FIG. 1 may receive, from the power distribution units, location information and characteristics of the power distribution units. In another implementation, the resource management unit 120 may receive at least some of the characteristics of the power distribution units in the form of manual input. In some implementations, servers may identify and indicate power distribution units (e.g., by a power distribution unit identifier) from which the servers receive power. The flow continues at block 406.

Cooling units associated with the server and characteristics of the cooling units are identified (406). The cooling units can include cooling fans, air conditioners, air vents, chilling devices, pumps, cooling towers, water cooling equipment, and other components that can dissipate heat generated by the server. A physical location of the cooling units associated with the server and a distance of the cooling unit relative to the server can be determined. In one implementation, location coordinates of the cooling units can be determined with respect to a fixed position in a server room. In another implementation, radio frequency identification (RFID) can be used to determine the position of the cooling units. As described above, position of the cooling units may be determined in terms of x, y, and z coordinates, where the z-coordinate represents a relative height of the cooling unit. A distance of the cooling units from the server and a direction of the airflow generated by the cooling units relative to the server may also be determined. In one implementation, based on knowledge of the position of the cooling units in the data center and based on knowledge of the position of the server within the data center, one or more cooling units within a threshold distance of the server may be identified. Additionally, an air flow diagram may be accessed to identify cooling units positioned in the direction of the server. The cooling units that generate an air flow in the direction of the server and that are within the threshold distance of the server can be identified as cooling units associated with the server. The characteristics of the cooling units associated with the server can include a cooling efficiency of the cooling unit, an amount of airflow generated by the cooling unit, cooling capacity of the cooling unit, power consumption of the cooling unit, heat generated by the cooling unit, and other operating characteristics and specifications of the cooling units. In addition to determining the characteristics and the physical location of the cooling units, a target temperature of the server being cooled by the cooling units may also be determined. In one implementation, the cooling units can comprise functionality to determine and communicate their respective characteristics to the centralized processing unit (e.g., the resource management unit 120) that generates the power consumption database. In another implementation, the resource management unit 120 may receive at least some of the characteristics of the cooling units in the form of manual input. The flow continues at block 408.

Additional energy consumption elements are identified (408). The additional energy consumption elements can comprise components of the data center including peripheral components, management servers, maintenance consoles, etc. The flow continues at block 410.

The power consumption database that identifies relationships between the server and the associated power distribution units and the cooling units is generated (410). As described above, the power consumption database 128 indicates relationships and dependencies between various components of the cloud network 102. As described herein, the power consumption database 128 can indicate the relationship between a particular server and facilities elements including the power distribution units and the cooling units associated with the server. The power consumption database 128 can also comprise a listing of the additional energy consumption elements and their relationship to the servers, the power distribution units, and/or the cooling units. The power consumption database 128 can be implemented as a tree structure or other suitable data structure. From block 410, the flow ends.

It should be understood that FIGS. 1-4 are examples meant to aid in understanding embodiments and should not be used to limit embodiments or limit scope of the claims. Embodiments may perform additional operations, fewer operations, operations in a different order, operations in parallel, and some operations differently. For example, although FIG. 2 describes resources of potential target servers associated with the lowest energy cost being allocated for servicing the request (see block 222), embodiments are not so limited. In some implementations, other factors such as available unallocated resources of the potential target servers may also be taken into consideration. For example, it may be determined that only a fraction of the resources of a first potential target server with the lowest energy cost can be allocated for servicing the request and that the resources for servicing the request can be completely allocated from a second potential target server with the second lowest energy cost. Accordingly, the resource management unit may choose to allocate resources from the second potential target server for servicing the request.

In one implementation, as depicted in FIG. 1, the cloud network 102 can comprise a single data center. In other words, servers, cooling units, power distribution units, and other co-located components of the data center may be aggregated to form the cloud network 102. In another implementation, the cloud network 102 can comprise multiple sets of servers in different data centers. For example, servers, cooling units, power distribution units, and other co-located components of a first data center may be aggregated with servers, cooling units, power distribution units, and other co-located components of a second data center to form the cloud network 102. Operations described herein can be executed to select server(s), across data centers, from which to allocate resources for servicing the request to maximize efficiency of a data center. The operations described herein can also be executed to select a data center (e.g., a data center with the lowest energy cost) from which to allocate resources, thus maximizing efficiency of the cloud network.

Although FIG. 2 describes resources of servers in the dormant state not being allocated for servicing the request (see block 206), embodiments are not so limited. In some implementations, if none of the other servers in the cloud network 102 can service the request, the server in the dormant state may be activated (e.g., by powering on the server, triggering the server to switch from an idle/sleep state to an active state, by activating cooling units associated with the server, etc.) for servicing the request. In determining whether a server in the dormant state is to be activated, energy costs associated with the server switching from the dormant state to the active state may also be considered.

It is also noted that operations described with reference to FIGS. 1-3 for selecting servers from which to allocate resources may be executed every time a request for cloud resources is received. Furthermore, after a requesting client (e.g., the client 112) relinquishes the cloud resources, the operations of FIGS. 1-3 can be executed again to reallocate resources and transfer workloads across servers and/or data centers to improve energy efficiency of the cloud network 102.

As will be appreciated by one skilled in the art, aspects of the present inventive subject matter may be embodied as a system, method, or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

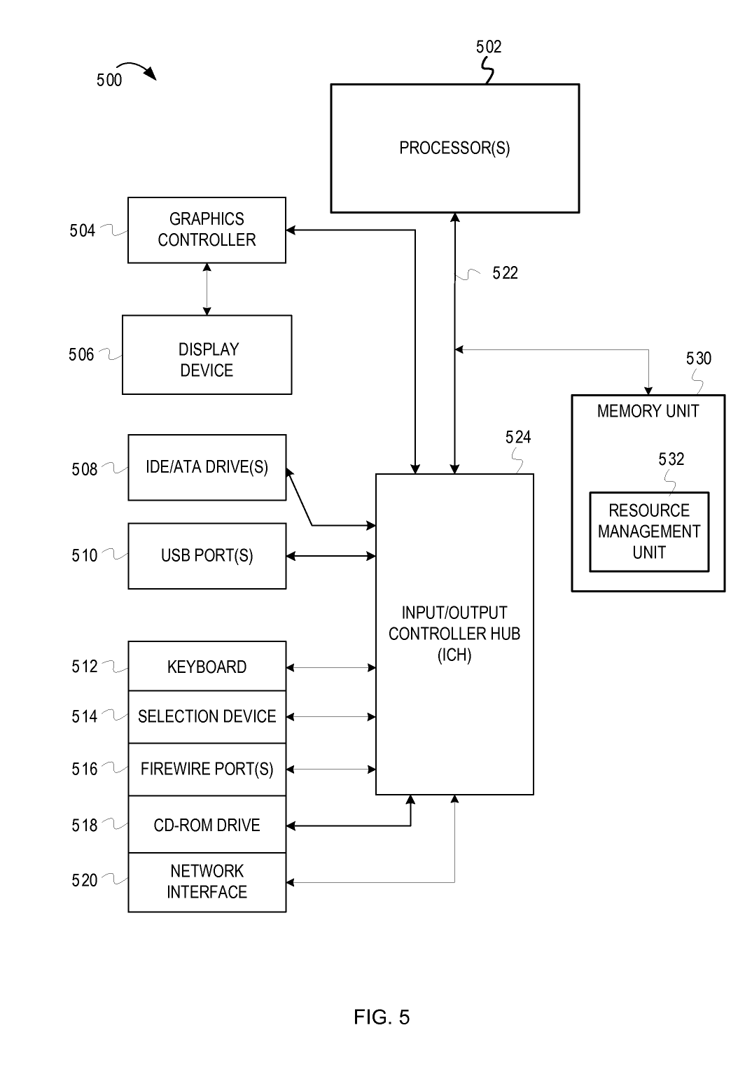

FIG. 5 is an example block diagram of a computer system 500 configured for identifying servers from which to allocate resources based on power consumption of the servers. The computer system 500 includes a processor 502. The processor 502 is connected to an input/output controller hub 524 (ICH), also known as a south bridge, via a bus 522 (e.g., PCI, ISA, PCI-Express, HyperTransport, etc). A memory unit 530 interfaces with the processor 502 and the ICH 524. The main memory unit 530 can include any suitable random access memory (RAM), such as static RAM, dynamic RAM, synchronous dynamic RAM, extended data output RAM, etc.

The memory unit 530 comprises a resource management unit 532. The resource management unit 532 embodies functionality to select target server(s) based, at least in part, on power consumption of a server, power consumption of facilities elements associated with the server, and projected increase in power consumption of the server if resources of the sever are allocated for servicing a request. The target server(s) from which resources are to be allocated for servicing the request can be selected to maximize energy efficiency of a cloud network as described above with reference to FIGS. 1-4.

The ICH 524 connects and controls peripheral devices. In FIG. 5, the ICH 524 is connected to IDE/ATA drives 508 and to universal serial bus (USB) ports 510. The ICH 524 may also be connected to a keyboard 512, a selection device 514, firewire ports 516, CD-ROM drive 518, and a network interface 520. The ICH 524 can also be connected to a graphics controller 504. The graphics controller is connected to a display device 506 (e.g., monitor). In some embodiments, the computer system 500 can include additional devices and/or more than one of each component shown in FIG. 5 (e.g., video cards, audio cards, peripheral devices, etc.). For example, in some instances, the computer system 500 may include multiple processors, multiple cores, multiple external CPU's. In other instances, components may be integrated or subdivided. Any one of these functionalities may be partially (or entirely) implemented in hardware and/or on the processor 502. For example, the functionality may be implemented with an application specific integrated circuit, in logic implemented in the processor 502, in a co-processor on a peripheral device or card, etc. Further, realizations may include fewer or additional components not illustrated in FIG. 5 (e.g., video cards, audio cards, additional network interfaces, peripheral devices, etc.).

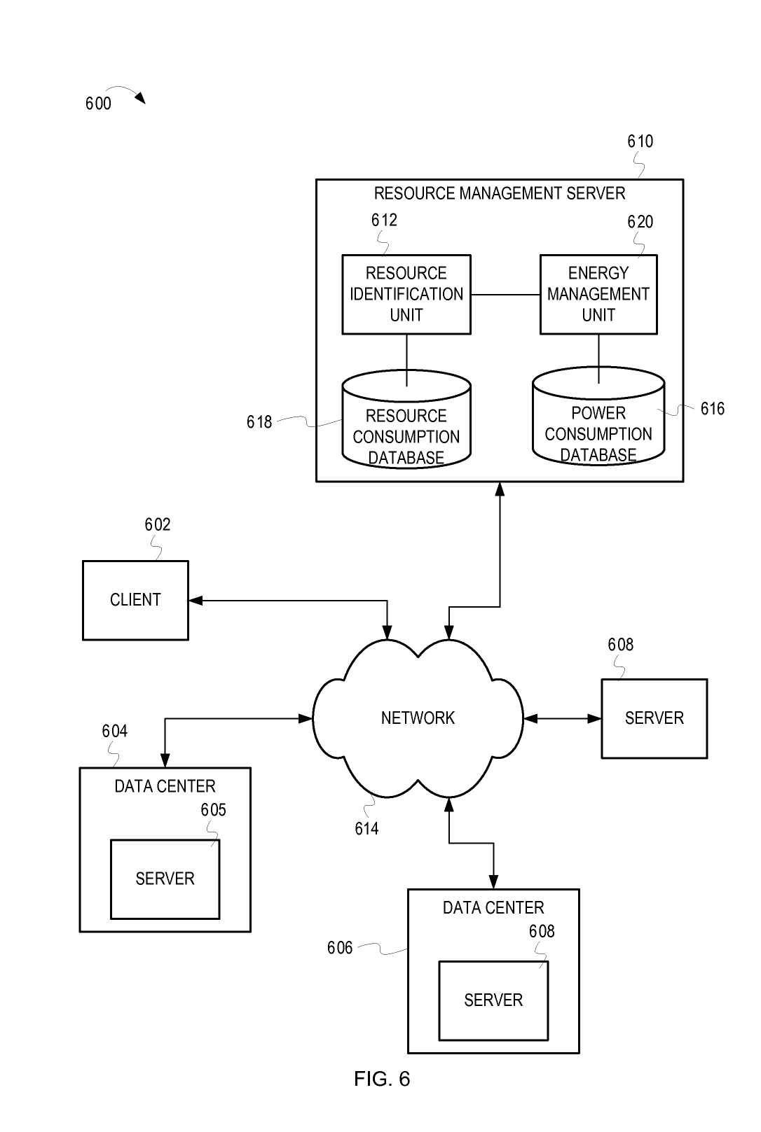

FIGS. 1-5 describe implementations, wherein the resource management unit 120 performs operations for identifying servers from which to allocate resources from a collection of servers within a data center. However, in some implementations, the resource management unit 120 may analyze servers across multiple data centers-each data center located in a different physical location. In some implementations, resources from a first server at a first physical location (e.g., in a first data center) and resources from a second server at a second physical location (e.g., in a second data center) may be allocated for servicing the request. Operations for allocating resources across a network of data centers are further described with reference to FIG. 6.

FIG. 6 is an example block diagram configured for allocating resources based on server energy efficiency. The system 600 comprises a data center 604, a data center 606, a client 602, and a resource management server 610. The data center 604 comprises a server 605 and the data center 606 comprises a server 608. The resource management server 610 comprises a resource identification unit 612, an energy management unit 620, a resource consumption database, and a power consumption database 616. The resource identification unit 612 is coupled with the energy management unit 620 and the resource consumption database. The energy management unit 620 is coupled with the power consumption database 616. The servers 605 and 608 of the data centers 604 and 606 respectively are aggregated to form a cloud network. It is noted that the data centers 604 and 606 can comprise any suitable number of servers. In some implementations, the resource management server 610 can be part of the cloud network, while in other implementations, the resource management server 610 may not be part of the cloud network. Although not depicted in FIG. 6, each of the servers 605 and 608 are also associated with power distribution units and cooling units.

The resource management server 610 receives a request for resources (e.g., memory and processor resources) from the client 602. As described above with reference to FIG. 1-4, the resource management server 610 analyses power consumption of the servers 604 and 608 and their associated facilities elements (not shown) to identify one or more most efficient servers. The resource management server 610 may also analyze power consumption and energy cost associated with the data centers 604 and 608 and allocate resources of the servers within the data center with the lowest energy cost.

The servers 605 and 608 and the resource management server 610 communicate via a communication network 614. The client 602 also communicates with the resource management server 610 via the communication network 614. The communication network 614 can include any technology (e.g., Ethernet, IEEE 802.11n, SONET, etc) suitable for passing communication between the resource management server 610 and the servers 605 and 608 and also between the resource management server 610 and the client 602. Moreover, the communication network 614 can be part of other networks, such as cellular telephone networks, public-switched telephone networks (PSTN), cable television networks, etc. Additionally, the resource management server 610 can be any suitable devices capable of executing software in accordance with the embodiments described herein.

While the embodiments are described with reference to various implementations and exploitations, it will be understood that these embodiments are illustrative and that the scope of the inventive subject matter is not limited to them. In general, techniques for maximizing power consumption efficiency through physical location correlation as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
determining a plurality of servers from which resources can be allocated to service a request;
for each server of the plurality of servers,
identifying a power distribution element and a cooling element associated with the server;
determining an energy cost based, at least in part, on power characteristics of the power distribution element and the cooling element associated with the server;
determining a lowest energy cost for servicing the request based, at least in part, on said determining the energy cost of each of the plurality servers; and
allocating at least a subset of the resources for servicing the request from a first of the plurality of servers based, at least in part, on said determining the lowest energy cost for servicing the request.

2. The method of claim 1, wherein said determining the lowest energy cost for servicing the request comprises determining that the first of the plurality of servers has the lowest of the energy costs determined for the plurality of servers.

3. The method of claim 1, wherein said determining the lowest energy cost for servicing the request comprises determining that the resources for servicing the request can be allocated from a first set of the plurality servers at a first aggregate energy cost that is lower than either a second aggregate energy cost for allocating the resources from a second set of the plurality of servers or the energy cost of allocating the resources from a second of the plurality of servers, wherein the first set of the plurality of servers includes the first of the plurality of servers.

4. The method of claim 1, wherein said determining the plurality of servers from which resources can be allocated to service the request comprises:
for each of a second plurality of servers, wherein the second plurality of servers comprise the plurality of servers,
determining, at the server, a current resource consumption that corresponds to allocated resources at the second of the plurality of servers;
determining whether the current resource consumption at the server is greater than a threshold resource consumption;
indicating that the available unallocated resources of the server cannot be allocated for servicing the request in response to determining that the current resource consumption at the server is greater than the threshold resource consumption;
determining at least a subset of the available unallocated resources of the server that can be allocated for servicing the request in response to determining that the current resource consumption at the server is not greater than the threshold resource consumption; and
identifying the plurality of servers as those of the second plurality of servers from which at least the subset of the available unallocated resources of the server that can be allocated for servicing the request.

5. The method of claim 4, wherein said determining the energy cost for each server of the plurality of servers comprises:
calculating, for each server of the plurality of servers, the energy cost for the server based, at least in part, on the at least the subset of the available unallocated resources of the server that can be allocated for servicing the request.

6. The method of claim 1, further comprising:
determining whether a second of the plurality of servers is in a dormant state, wherein the dormant state represents that the second of the plurality of servers is in a low-powered state and cooling elements associated with the second of the plurality of servers is in the low-powered state;
indicating that available unallocated resources of the second of the plurality of servers cannot be allocated for servicing the request in response to determining that the second of the plurality of servers is in the dormant state; and
determining the energy cost for the second of the plurality of servers in response to determining that the second of the plurality of servers is not in the dormant state.

7. The method of claim 1, wherein said determining the energy cost for each server of the plurality of servers comprises:
for each server of the plurality of servers,
estimating an increase in power consumption by the server and by the power distribution element and the cooling element associated with the server based on a simulated allocation of at least a subset of the resources from the server for servicing the request.

8. The method of claim 7, wherein said estimating the increase in power consumption for each server of the plurality of servers comprises:
for each server of the plurality of servers,
determining, at the server, a current resource consumption that corresponds to allocated resources at the server;
determining, at the server, a current temperature that corresponds to the current resource consumption at the server; and
estimating a temperature rise at the server that could occur if at least a subset of the available unallocated resources of the server are allocated for servicing the request.

9. The method of claim 8, further comprising:
for each server of the plurality of servers,
determining a new temperature at the server based on the current temperature at the server and on the temperature rise at the server that could occur if at least the subset of the available unallocated resources of the server are allocated for servicing the request;
determining that the new temperature at the server is greater than a threshold temperature; and
indicating that the at least the subset of the available unallocated resources of the server cannot be allocated for servicing the request in response to said determining that the new temperature at the server is greater than the threshold temperature.

10. The method of claim 1, wherein the power characteristics of the cooling element comprise at least one of a physical location of the cooling element, a cooling efficiency of the cooling element, a power consumption of the cooling element, a cooling capacity of the cooling element, a distance between the cooling element and one of the plurality of servers associated with the cooling element, and a direction of airflow of the cooling element relative to the one of the plurality of servers associated with the cooling element.

11. The method of claim 1, wherein the plurality of servers constitute one of:
a cloud computing network wherein one or more of the plurality of servers are located at distinct physical locations, and
a data center, wherein each server of the plurality of servers is located at a common physical location.

12. The method of claim 1, wherein said determining the energy cost for each server of the plurality of servers comprises:
for each server of the plurality of servers, calculating a monetary cost for the server based, at least in part, on power consumption by the server.

13. A computer program product for maximizing power utilization efficiency, the computer program product comprising:
a computer readable storage medium having computer usable program code embodied therewith, the computer readable program code configured to,
determine a plurality of servers from which resources can be allocated to service a request;
for each server of the plurality of servers,
identify a power distribution element and a cooling element associated with the server;
determine an energy cost based, at least in part, on power characteristics of the power distribution element and the cooling element associated with the server;
determine a lowest energy cost for servicing the request based, at least in part, on the computer readable program code determining the energy cost of each of the plurality of servers; and
allocate at least a subset of the resources for servicing the request from a first of the plurality of servers based, at least in part, on the computer readable program code determining the lowest energy cost for servicing the request.

14. The computer program product of claim 13, wherein the computer readable program code configured to determine the plurality of servers from which resources can be allocated to service the request comprises the computer readable program code configured to:
for each of a second plurality of servers, wherein the second plurality of servers comprise the plurality of servers,
determine, at the server, a current resource consumption that corresponds to allocated resources at the server;
determine whether the current resource consumption at the server is greater than a threshold resource consumption;
indicate that available unallocated resources of the server cannot be allocated for servicing the request in response to the computer readable program code determining that the current resource consumption at the server is greater than the threshold resource consumption;
determine at least a subset of the available unallocated resources of the server that can be allocated for servicing the request in response to the computer readable program code determining that the current resource consumption at the server is not greater than the threshold resource consumption; and
identify the plurality of servers as those of the second plurality of servers from which at least the subset of the available unallocated resources of the server that can be allocated for servicing the request.

15. The computer program product of claim 13, wherein the computer readable program code is further configured to:
determine whether a second of the plurality of servers is in a dormant state, wherein the dormant state represents that the second of plurality of servers is in a low-powered state and cooling elements associated with the second of the plurality of servers is in the low-powered state;
indicate that available unallocated resources of the second of the plurality of servers cannot be allocated for servicing the request in response to the computer readable program code determining that the second of the plurality of servers is in the dormant state; and
determine the energy cost for the second of the plurality of servers in response to the computer readable program code determining that the second of the plurality of servers is not in the dormant state.

16. The computer program product of claim 13, wherein the computer readable program code configured to determine the energy cost for each server of the plurality of servers comprises the computer readable program code configured to:
for each server of the plurality of servers,
estimate an increase in power consumption by the server and by the power distribution element and the cooling element associated with the server based on a simulated allocation of at least a subset of the resources from server for servicing the request.

17. The computer program product of claim 16, wherein the computer readable program code configured to estimate the increase in power consumption for each server of the plurality of servers comprises the computer readable program code configured to:
for each server of the plurality of servers,
determine, at the server, a current resource consumption that corresponds to allocated resources at the server;
determine, at the server, a current temperature that corresponds to the current resource consumption at the server; and
estimate a temperature rise at the server that could occur if at least a subset of the available unallocated resources of the server are allocated for servicing the request.

18. The computer readable storage media of claim 17, wherein the computer readable program code is further configured to:
for each server of the plurality of servers,
determine a new temperature at the server based on the current temperature at the server and on the temperature rise at the server that could occur if at least the subset of the available unallocated resources of the server are allocated for servicing the request;
determine that the new temperature at the server is greater than a threshold temperature; and
indicate that the at least the subset of the available unallocated resources of the server cannot be allocated for servicing the request in response to the computer readable program code determining that the temperature rise at the server is greater than the threshold temperature.

19. An apparatus comprising:
a processor;
a network interface coupled with the processor;
a resource identification unit coupled with the processor and with the network interface, the resource identification unit operable to:
determine a plurality of servers from which resources can be allocated to service a request;
an energy management unit operable to:
for each server of the plurality of servers,
identify a power distribution element and a cooling element associated with the server;
determine an energy cost based, at least in part, on power characteristics of the power distribution element and the cooling element associated with the server;
determine a lowest energy cost for servicing the request based, at least in part, on the energy management unit determining the energy cost of each of the plurality of servers; and
the resource identification unit operable to:
allocate at least a subset of the resources for servicing the request from a first of the plurality of servers based, at least in part, on the energy management unit determining the lowest energy cost for servicing the request.

20. The apparatus of claim 19, wherein the resource identification unit and the energy management unit comprise the computer readable storage medium.
